(19) United States
(12) Patent Application Publication
(10) Pub. No.: US 2008/0089061 A1
(43) Pub. Date: Apr. 17, 2008

(54) DIRECT TYPE BACKLIGHT MODULE

(75) Inventors: Chung-Chih Hsieh, Taipei City (TW); Tsao-Yuan Fu, Taoyuan Hsien (TW); Chi-Sheng Lin, Taoyuan County (TW); Wen-Yu Lin, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CHUNGHWA PICTURE TUBES, LTD., Taipei (TW)

(21) Appl. No.: 11/754,322

(22) Filed: May 28, 2007

(30) Foreign Application Priority Data
Oct. 13, 2006 (TW) 95137670

(51) Int. Cl. F21V 17/06; F21S 2/00

(52) U.S. Cl. 362/235; 362/249

(57) ABSTRACT

A direct type backlight module including a frame, a plurality of light sources, an optical plate and an upper frame is provided. The frame includes a bottom frame and a side frame extending upward from the edge of the bottom frame. The light sources are disposed on the bottom frame, and the optical plate is disposed on the side frame above the light sources. The frame and the upper frame are assembled, wherein the optical plate is located between the upper frame and the frame. The upper frame has at lease one protrusion located above the optical plate and protruding to the optical plate. Therefore, the deformation of the optical plate can be reduced.

### CROSS-REFERENCE TO RELATED APPLICATION

This application claims the priority benefit of Taiwan application serial no. 95137670, filed Oct. 13, 2006. All disclosure of the Taiwan application is incorporated herein by reference.

### BACKGROUND OF THE INVENTION

1. Field of the Invention

The present invention relates to a light-source module, and more particularly to a direct type backlight module.

2. Description of Related Art

Along with the increasing demand of display devices, manufacturers in this industry have endeavored to improve the quality of display devices. The cathode ray tube (CRT) display, in particular, has played a dominant role in the display market for years due to its extraordinary displaying quality and technical maturity. Compared with other display categories, the CRT display not only has the disadvantages of high power consumption and high radiation adverse to environmental protection, but also has larger product volume, which cannot meet the demanding trend of lighter, thinner, shorter, smaller, more compact, and low power consumption in the display market. Therefore, thin film transistor liquid crystal displays (TFT-LCD), having superior properties such as high image quality, good space utilization, low power consumption and no radiation, have become the mainstream in the display market.

The TFT-LCD mainly includes a liquid crystal display panel and a backlight module. The liquid crystal display panel generally includes a thin film transistor array substrate, a color filter substrate and a liquid crystal layer disposed between the two substrates. The backlight module provides a planar light source for the liquid crystal display panel to perform the display function. In addition, the backlight module can be divided into two types: the direct type backlight module and the edge type backlight module. Compared with the edge type backlight module, the direct type backlight module can provide a planar light source having higher brightness. Thus, if the demanded brightness level for a display module is high, a direct type backlight module is often deployed. Following is a detailed description of the conventional direct type backlight module.

FIG. 1 is a schematic cross-sectional view showing a conventional direct type backlight module. Referring to FIG. 1A, a conventional direct type backlight module 100 includes a frame 110, a plurality of light sources 120, a diffusion plate 130, an upper frame 140 and at least one optical film 150, wherein the frame 110 includes a bottom frame 112 and a side frame 114 extending upward from the edge of the bottom frame 112. The light sources 120 are disposed on the bottom frame 112, and the diffusion plate 130 and the optical film 150 are disposed on the side frame 114 above the light sources 120. The upper frame 140 is assembled to the frame 110, wherein the diffusion plate 130 and the optical film 150 are disposed between the upper frame 140 and the frame 110.

FIG. 1B is a perspective view showing the deformation of the optical film of a conventional direct type backlight module. Please referring to FIG. 1B, with the demands for larger size liquid crystal displays, the size of the diffusion plate 130 and the optical film 150, which are disposed in the conventional direct type backlight module 100, is getting larger as well. However, the diffusion plate 130 and optical film 150 often warp and deform due to the temperature, humidity or the gravity when used or rested for long hours under a sever environment of heat and humidity, thus affecting the image quality of the liquid crystal displays having the direct type backlight module 100.

### SUMMARY OF THE INVENTION

This invention provides a direct type backlight module capable of reducing deformation and warping of the optical films.

This invention is directed to a direct type backlight module capable of improving the quality of displaying.

The present invention provides a direct type backlight module includes a frame, a plurality of light sources, an optical plate and an upper frame. The frame includes a bottom frame and a side frame extending upward from the edge of the bottom frame. The light sources are disposed on the bottom frame, and the optical plate is disposed on the side frame above the light sources. The frame and the upper frame are assembled, wherein the optical plate is located between the upper frame and the frame. The upper frame has at lease one protrusion located above the optical plate.

In one embodiment of the present invention, a distance between the top surface of the protrusion and the optical plate is between 0 to 0.1 mm.

In one embodiment of the present invention, the optical plate has at least one concave to contain the protrusion.

In one embodiment of the present invention, the shape of the protrusion includes cylinder or strip.

In one embodiment of the present invention, the side frame has a recess and the optical plate is disposed on the recess.

In one embodiment of the present invention, the direct type backlight module further includes at least one optical film disposed on the optical plate, and the protrusion is disposed on the outside of the optical film.

In one embodiment of the present invention, the optical plate includes a diffusion plate.

In one embodiment of the present invention, the light sources include point light sources or linear light sources.

The present invention further provides another direct type backlight module includes a frame, a plurality of light sources, an optical plate and an upper frame, wherein the frame includes a bottom frame and a side frame extending upward from the edge of the bottom frame. The light sources are disposed on the bottom frame, and the optical plate is disposed on the side frame above the light sources. The optical plate has at least one protrusion. The frame and the upper frame are assembled and the upper frame covers the protrusion, wherein the optical plate is located between the frame and the upper frame.

In one embodiment of the present invention, a distance between the top surface of the protrusion and the upper frame is between 0 to 0.1 mm.

In one embodiment of the present invention, the upper frame has at least one concave to contain the protrusion.

In one embodiment of the present invention, the shape of the protrusion includes cylinder or strip.

In one embodiment of the present invention, the side frame has a recess and the optical plate is disposed on the recess.

In one embodiment of the present invention, the direct type backlight module further includes at least one optical film disposed on the optical plate, and the protrusion is located on the outside of the optical film.

In one embodiment of the present invention, the optical plate includes a diffusion plate.

In one embodiment of the present invention, the light sources include point light sources or linear light sources.

The present invention provides a direct type backlight module having a protrusion on the frame or on the optical plate to reduce the warping and deformation of the optical plate; therefore display mura phenomenon of the liquid crystal displays that employed the above described direct type backlight module at a high temperature environment may be reduced.

In order to make the aforementioned and other objectives, features and advantages of the present invention comprehensible, preferred embodiments accompanied with figures are described in detail below.

### BRIEF DESCRIPTION OF THE DRAWINGS

FIG. 1A is a schematic cross-sectional view showing a conventional direct type backlight module.

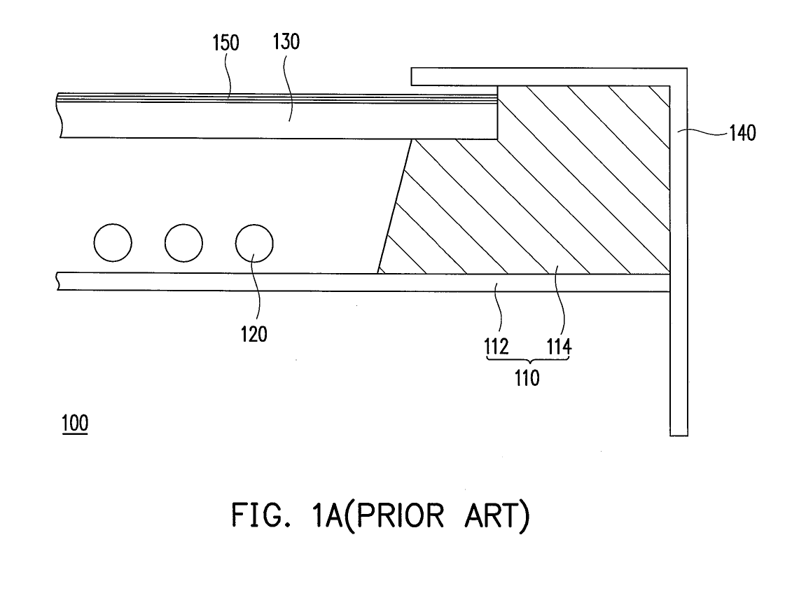

FIG. 1B is a perspective view showing the deformation of the optical film of a conventional direct type backlight module.

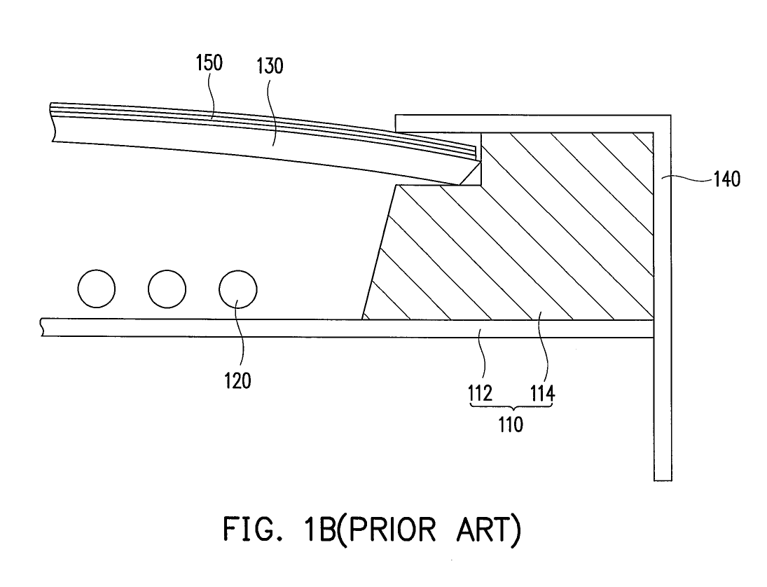

FIG. 2 is a schematic cross-sectional view showing a direct type backlight module according to the first embodiment of the present invention.

FIG. 3 is a schematic cross-sectional view showing a direct type backlight module according to the second embodiment of the present invention.

FIG. 4 is a schematic cross-sectional view showing a direct type backlight module according to the third embodiment of the present invention.

### DESCRIPTION OF EMBODIMENTS

### First Embodiment

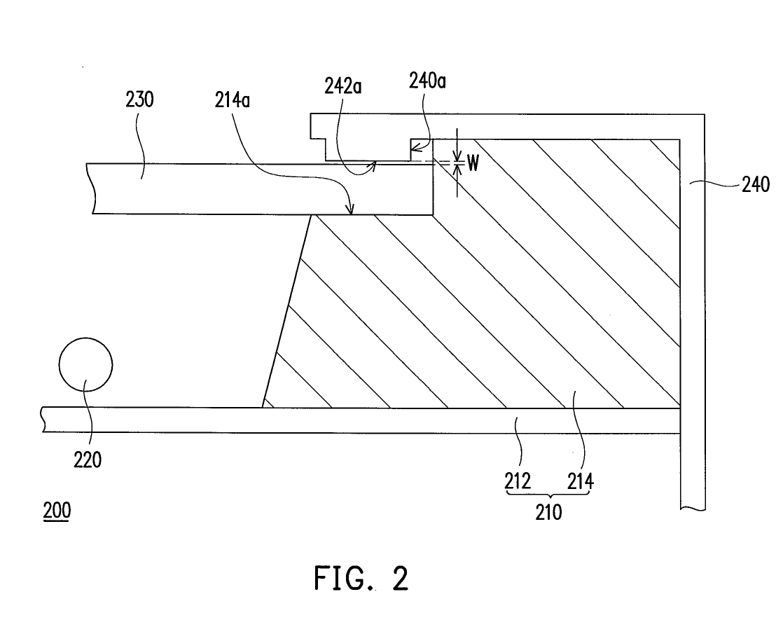

FIG. 2 is a cross sectional view showing a direct type backlight module according to the first embodiment of the present invention. Please referring to FIG. 2, the direct type backlight module 200 of the present embodiment includes a frame 210, a plurality of light sources 220, an optical plate 230 and an upper frame 240, wherein the frame 210 includes a bottom frame 212 and a side frame 214 extending upward from the edge of the bottom frame 212. The light sources 220 are disposed on the bottom frame 212, and the optical plate 230 is disposed on the side frame 214 above the light sources 220. The frame 210 and the upper frame 240 are assembled, wherein the optical plate 230 is located between the upper frame 240 and the frame 210. It should be noted that the upper frame has at least one protrusion 240a located above the optical plate 230 and protruding to the optical plate 230.

More specifically, the distance W between the top surface 242a of the protrusion 240a and the optical plate 230 is, for example, between 0 to 0.1 mm. In addition, the material of the protrusion 240a can be metal or plastic and the shape of the protrusion 240a could be cylinder or strip. The optical plate 230 is, for example, a diffusion plate and the light sources 220 could be point light sources or linear light sources. The linear light sources are, for example, cold cathode fluorescent lamp (CCFL), and the point light sources may be light emitting diode (LED), organic light emitting diode (OLED), or other similar light sources. In the present embodiment, the side frame 214 has a recess 214a and the optical plate 230 is disposed on the recess 214a. However, the side frame 214 in the present invention is not limited to have the recess 214a.

The deformation of the optical plate 230 can be reduced because the protrusion 240a is restraining the warping and deformation of the optical plate 230 at a high temperature environment, and thus the display mura phenomenon can be reduced.

### Second Embodiment

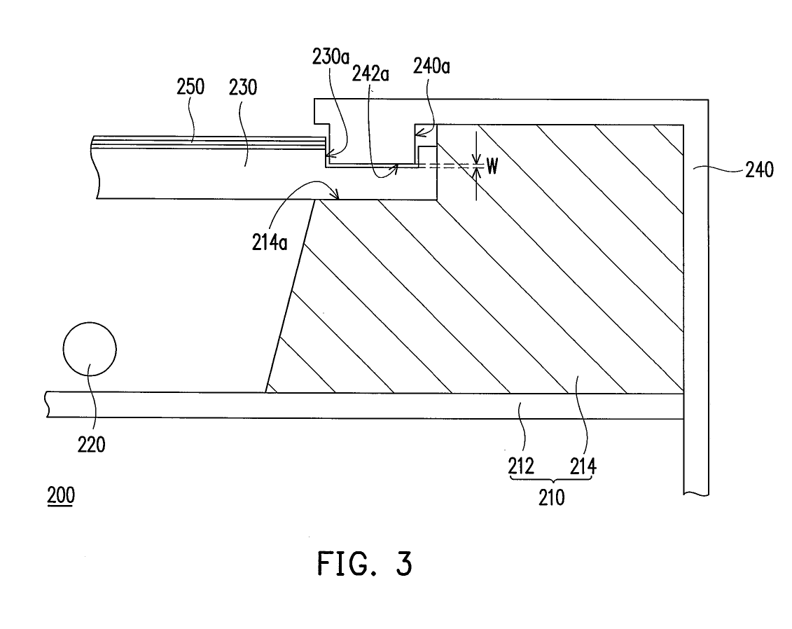

FIG. 3 is a cross sectional view showing a direct type backlight module according to the second embodiment of the present invention. Referring to FIG. 3, the present embodiment is similar to the first embodiment, but the difference is that the optical plate 230 has at lease one concave 230a to contain the protrusion 240a. Moreover, the distance W between the top surface 242a of the protrusion 240a and the concave 230a is, for example, between 0 to 0.1 mm. Therefore, the shifting of the optical plate 230 is restricted by the protrusion 240a and thus the display mura phenomenon can be reduced. In addition, a predetermined gap is maintained between the upper frame 240 and an optical film 250.

In the present embodiment, the direct type backlight module 200 further includes at least one optical film 250 disposed on the optical plate 230, and the protrusion 240a is located on the outside of the optical film 250. Additionally, the optical film 250 is, for example, a lower diffusion film, a light-collecting film, an upper diffusion film or other optical film.

### Third Embodiment

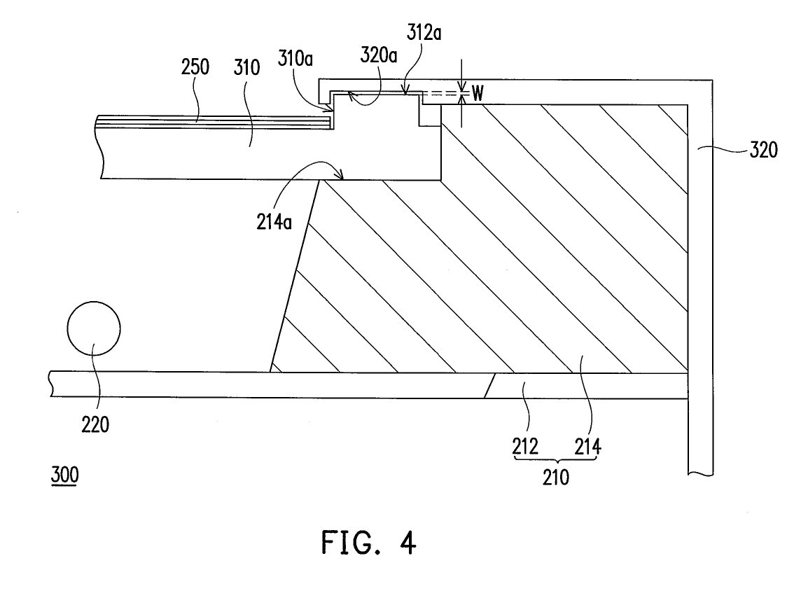

FIG. 4 is a cross sectional view showing a direct type backlight module according to the third embodiment of the present invention. Referring to FIG. 4, this embodiment is similar to the second embodiment, the difference is that the optical plate 310 of the direct type backlight module 300 of the present embodiment has at least one protrusion 310a located at the edge thereof and the upper frame 320 covers the protrusion 310a. Wherein, the shape of the protrusion 310a is, for example, cylinder or strip. In the present embodiment, the upper frame 320 has at least one concave 320a to contain the protrusion 310a. However, the upper frame 320 of the present embodiment is not limited to include a concave 320a, and the upper frame 320 without a concave 320a (as shown in the FIG. 2) can be applied to the present embodiment as well.

The distance W between the top surface 312a of the protrusion 310a and the concave 320a is, for example, between 0 to 0.1 mm. Therefore, the shifting of the optical plate 310 is restricted by the concave 320a and thus the display mura phenomenon can be reduced.

The present invention has been disclosed above in the embodiments, but is not limited to those. It is known to persons skilled in the art that some modifications and innovations may be made without departing from the spirit and scope of the present invention. Therefore, the scope of the present invention should be defined by the following claims.

What is claimed is:

1. A direct type backlight module, comprising:
a frame, including a bottom frame and a side frame extending upward from the edge of the bottom frame;
a plurality of light sources disposed on the bottom frame;
an optical plate disposed on the side frame and located above the light sources; and
an upper frame, assembled with the frame and has at least one protrusion located above the optical plate, wherein the optical plate is located between the frame and the upper frame.

2. The direct type backlight module as claimed in claim 1, wherein the distance between a top surface of the protrusion and the optical plate is between 0 to 0.1 mm.

3. The direct type backlight module as claimed in claim 1, wherein the optical plate has at least one concave to contain the protrusion.

4. The direct type backlight module as claimed in claim 1, wherein the shape of the protrusion comprises cylinder or strip.

5. The direct type backlight module as claimed in claim 1, wherein the side frame has a recess and the optical plate is disposed on the recess.

6. The direct type backlight module as claimed in claim 1, further comprising an optical film, disposed on the optical plate and the protrusion is located on the outside of the optical film.

7. The direct type backlight module as claimed in claim 1, wherein the optical plate comprises a diffusion plate.

8. The direct type backlight module as claimed in claim 1, wherein the light sources comprise point light sources or linear light sources.

9. A direct type backlight module, comprising:
a frame, including a bottom frame and a side frame extending upward from the edge of the bottom frame;
a plurality of light sources disposed on the bottom frame;
an optical plate disposed on the side frame and has at least one protrusion, wherein the optical plate located above the light sources; and
an upper frame, assembled with the frame and covers the protrusion, wherein the optical plate is located between the frame and the upper frame.

10. The direct type backlight module as claimed in claim 9, wherein the distance between a top surface of the protrusion and the upper frame is between 0 to 0.1 mm.

11. The direct type backlight module as claimed in claim 9, wherein the upper frame has at least one concave to contain the protrusion.

12. The direct type backlight module as claimed in claim 9, wherein the shape of the protrusion comprises cylinder or strip.

13. The direct type backlight module as claimed in claim 9, wherein the side frame has a recess and the optical plate is disposed on the recess.

14. The direct type backlight module as claimed in claim 9, farther comprising an optical film, disposed on the optical plate and the protrusion is located on the outside of the optical film.

15. The direct type backlight module as claimed in claim 9, wherein the optical plate comprises a diffusion plate.

16. The direct type backlight module as claimed in claim 9, wherein the light sources comprises point light sources or linear light sources.
